(19) United States
(12) Patent Application Publication
(10) Pub. No.: US 2011/0000130 A1
(43) Pub. Date: Jan. 6, 2011

(54) Plant container

(76) Inventor: Taunya Miller, Blanco, TX (US)

Correspondence Address: ROBERT IRELAND, P.O. BOX 273, BANKS, OR, 97124, US

(21) Appl. No.: 12/653,248

(22) Filed: Dec. 9, 2009

Related U.S. Application Data
(60) Provisional application No. 61/270,095, filed on Jul. 2, 2009.

(51) Int. Cl. A01G 9/02

(52) U.S. Cl. 47/65.5

(57) ABSTRACT

A container structure for growing a plant comprises a container including at least one upwardly extending side wall having a top end and a bottom end. The bottom end is coupled with at least one bottom wall. The plant container structure further comprises a conical member extending from or inserted within a central position of the at least one bottom wall. The conical member comprises at least one top surface and at least one bottom surface. The conical member being upwardly facing towards the top end of the at least one container side wall. The conical member further comprises a plurality of air openings being disposed through the conical member. The plurality of air openings may increase from the at least one top surface to the at least one bottom surface.

### BACKGROUND OF THE INVENTION

1. Technical Field of the Invention

The present invention relates in general to a plant container. More specifically, the present invention relates to a conical member having a plurality of air openings being disposed through the conical member and extending from the central position within a plant container.

2. Description of the Related Art

Plant containers are widely used as a means for growing plants all over the world. The history of plant containers dates back many centuries. Various plant containers like gourds, shells and potteries were used as the forming medium by which plants and its necessary soil and hydration were contained. Typically, the modern concept of containment is accomplished by moulded plastic, glass, and other materials for providing non-porous and water proof containment.

The roots of all plant species need oxygen for healthier growth. In nature, the essential supply of oxygen comes mainly from intrinsic air in the soil. In a manmade pot however, conditions for oxygenation of root systems are less than ideal as water is contained and has nowhere to seep away from the root structure, so there is no space for air, and critical oxygen has no effective way to disperse into the soil or growing medium. In order to address the above mentioned problems plant containers with different dimensions were developed.

Many attempts have been made for manufacturing plant containers adapted for providing more oxygen to the plant root structure. One of such solution was to provide a plant container that can be partially filled with water prior to shipping the plant. This container failed to provide a conical structure to prevent over watering by introducing oxygen to the root structure and surrounding soils. Moreover, this container is not adapted to resist the effects of hypoxia and/or compaction of soil.

Certain other plant containers utilize a flat false bottom for providing excess moisture below the root structure and soil. As such, these arrangements is complex and have water drainage holes that would allow limited aeration only to a limited amount of soil or growing medium at the flat false bottom. However, this container failed to prevent compaction of the soil, growing medium or the like.

Hence, it can be seen, that there is a need for a plant container having a conical member with a plurality of air openings adapted for providing more oxygen to the plant root structure. Further, the needed container would prevent over watering by providing a plurality of air openings disposed through the conical member. Moreover, the needed arrangement would be simple, economical, and would be designed to be stacked for easy storage and inexpensive shipping. Moreover, the needed arrangement would be adapted to resist the effects of hypoxia and/or compaction of soil.

### SUMMARY OF THE INVENTION

To minimize the limitations found in the prior art, and to minimize other limitations that will be apparent upon the reading of the specifications, the present invention provides a container structure for growing a plant comprises a container including at least one upwardly extending side wall having a top end and a bottom end. The bottom end is coupled with at least one bottom wall. The plant container structure further comprises a conical member extending from a central position of the at least one bottom wall of the container. The conical member comprises at least one top surface and at least one bottom surface. The at least one top surface generally being smaller in surface area includes a plurality of holes thereon. The conical member being upwardly facing towards the top end of the at least one container side wall. The container structure further comprises a plurality of air openings being disposed through the conical member. The conical member with the plurality of air openings integrated within the container is adapted for diffusing gaseous oxygen into the soil, growing medium or the like. The conical member provides the advantage of replacing the soil within the container that is subjected to hypoxia and/or compaction of soil. The plurality of air openings generally increases from the at least one top surface to the at least one bottom surface thereby reducing hypoxia and/or compaction of soil.

In another aspect of the present invention, the plurality of air openings may be slits. The slits are being disposed through the conical member. The slits form the plurality of air openings for providing oxygen to the interior soil, growing medium or the like. The slits generally being horizontally disposed through the conical member. In yet another aspect of the present invention, the at least one top surface of the conical member may include a plurality of air openings. The plurality of air openings may be a slot, hole or the like. The slot, hole or the like may generally being horizontally disposed through the conical member.

A first objective of the invention is to provide a container structure for growing a plant to maturity and yield, having a plurality of air openings disposed through a conical member to diffuse gaseous oxygen into the soil, growing medium or the like.

A second objective of the invention is to provide a container structure insert for growing a plant to maturity, said insert having a plurality of air openings disposed through a conical member to diffuse gaseous oxygen into the soil, growing medium or the like.

A third objective of the invention is to provide a container structure to enhance aeration of soil, growing medium or the like at the interior of the container.

Another objective of the invention is to provide a container structure for growing the plant wherein the plurality of air openings generally increases from the at least one top surface to the at least one bottom surface.

Another objective of the invention is to provide an uninterrupted flow of gaseous oxygen and other gases between the outside atmosphere, and soil, growing medium or the like within the plant container.

Yet another objective of the invention is to provide a container structure that can resist the effects of hypoxia and/or compaction of soil.

Still another objective of the invention is to provide a desired water reservoir within the container structure and also provide protection against over watering.

A further objective of the invention is to provide a container structure that may be stacked for easy storage and inexpensive shipping.

Another objective of the invention is to provide a container structure that requires less soil, growing medium or the like, for growing a plant in the same size pot.

It is also the objective of the invention is to provide a container structure that requires less nutrients and less chemicals while providing greater yields for mature plants.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a cut-away view of the preferred embodiment in accordance with the present invention showing a container structure having a conical member with a plurality of openings integrated thereon;

FIG. 2 is a cut-away view of the present invention showing the diffusion of gaseous oxygen into the soil, growing medium or the like;

FIG. 3 is a cut-away view of the present invention showing the growth of roots in a container structure;

FIG. 4 is a perspective view of the present invention, illustrating the conical member insert without container;

FIG. 5 is a perspective view of another embodiment of the present invention illustrating the conical member insert without container having vertically disposed slots; and

FIG. 6 is a perspective view of a plant container structure showing a multi perspective rendering of the embodiment of FIG. 5 integrated with the container embodiment of FIG. 1-3.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

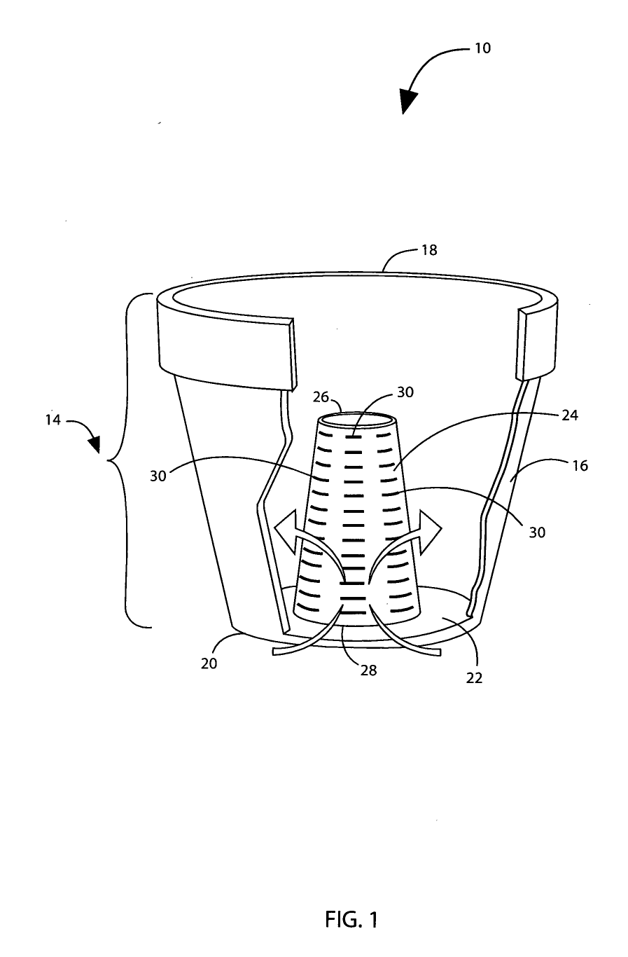

FIG. 1 is a cut-away view of a container structure 10 in accordance with the present invention comprises a conical member 24 with a plurality of air openings thereon 30 integrated in this embodiment within a container 14. Other embodiments involve a conical member 24 as an insert which is not integrated with the container 14. In this FIG. 1 illustration, the container 14 includes at least one upwardly extending side wall 16 having a top end 18 and a bottom end 20 wherein the bottom end 20 is coupled with at least one bottom wall 22. The conical member 24 extending from a central position of the at least one bottom wall 22 of the container 14. The conical member 24 comprises at least one top surface 26 and at least one bottom surface 28. The at least one top surface 26 generally being smaller in surface area includes a plurality of air openings 30 thereon and the at least one bottom surface 28 being generally larger in surface area. The conical member 24 is upwardly facing towards the top end 18 of the at least one container side wall 16. The container structure 10 further comprises a plurality of air openings 30 being disposed through the conical member 24. The conical member 24 with the plurality of air openings 30 integrated within the container 14 is adapted for diffusing gaseous oxygen into the soil, growing medium or the like.

As shown in FIG. 1, the direction of arrows shows the flow of air inside the conical member 24 through the plurality of air gaps 30 and out into the interior of the plant container 14 thereby aerating the soil or growing medium. The aerating also allows the microbes to fix gaseous nitrogen well below a soil line, providing the roots with continued nutrition. The conical member 24 provides the advantage of replacing the soil within the container that is subjected to hypoxia and/or compaction of soil. Moreover, the plurality of air openings 30 may increase from the at least one top surface 26 to the at least one bottom surface 28 thereby reducing hypoxia and/or compaction of soil.

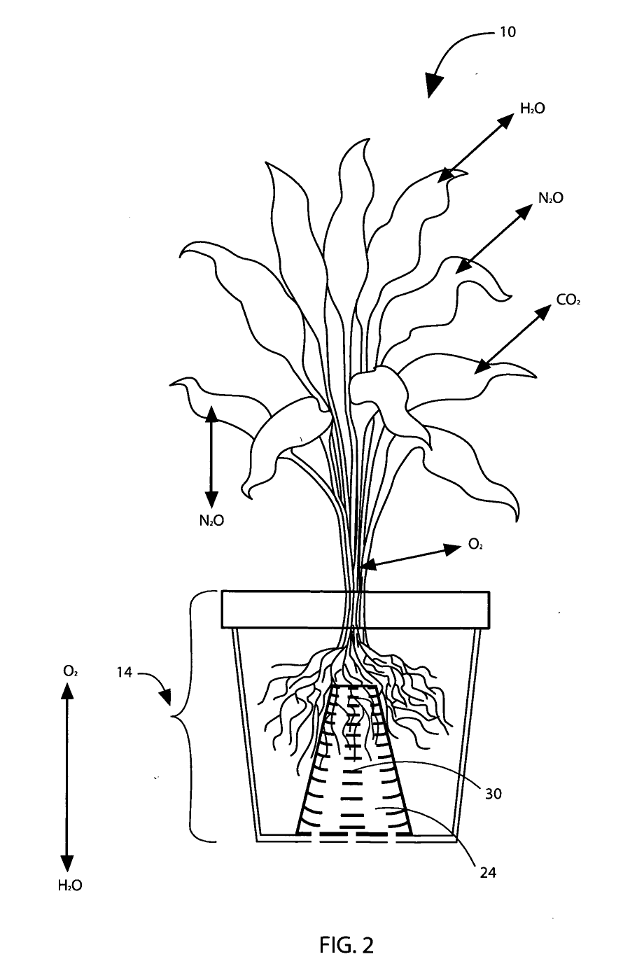

FIG. 2 is a cut-away view of the present invention showing the diffusion of gaseous oxygen into the soil, growing medium or the like. The conical member 24 is designed to provide internal aeration through the plurality of air openings 30 and also arranged to drain off excess or standing water from the container 14. A desired depth of water saturation can be maintained by adjusting the air openings 30 of the conical member 24.

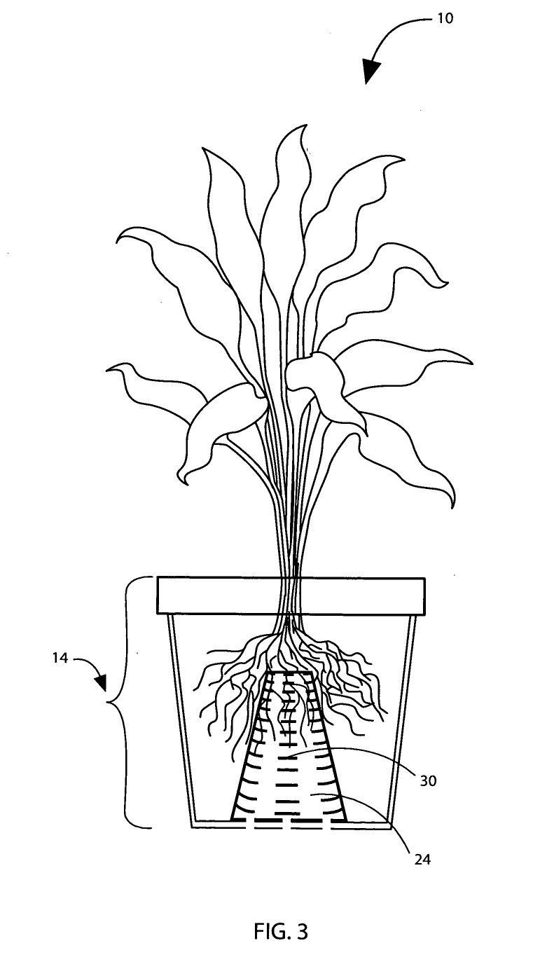

FIG. 3 is a cut-away view of the present invention showing the growth of roots in a container structure 10. The plurality of air openings 30 provides aeration to the area within the plant container structure 10 thereby reducing hypoxia and/or compaction of soil. As such, the plurality of air openings 30 replaces the normally compacted and hypoxic space by introducing additional oxygen resulting in the accelerated growth of roots.

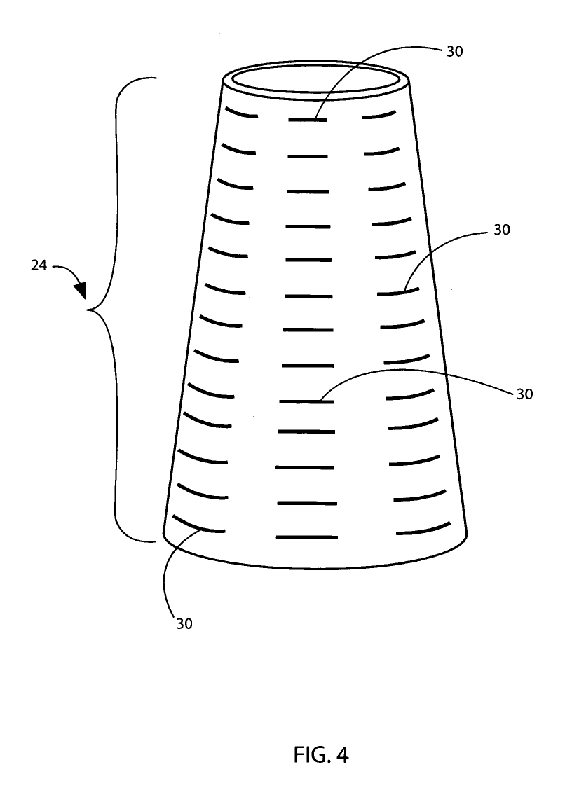

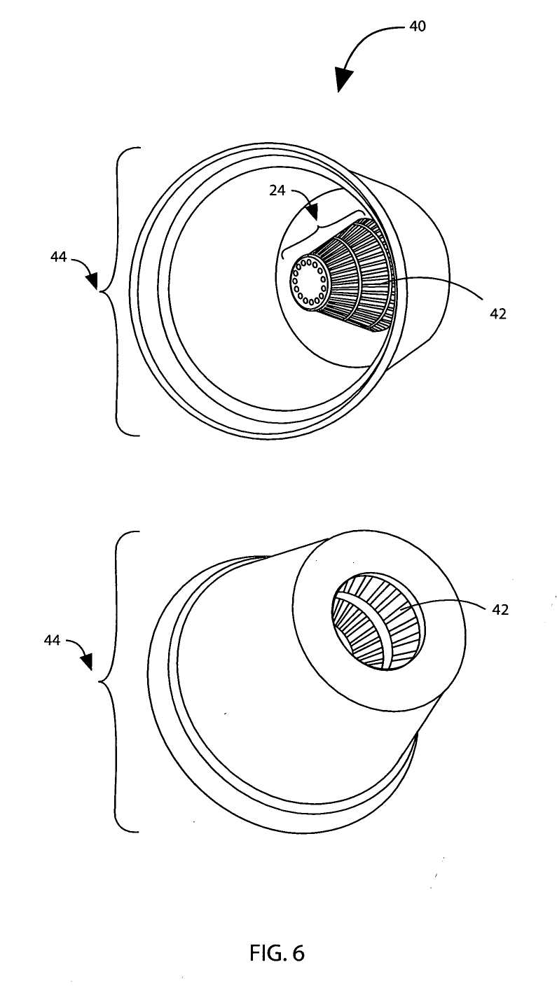

FIG. 4 is a perspective view of the present invention, illustrating a conical member 24. The plurality of air openings 30 may be slits as indicated herein, vertical or horizontal slits, or the like. The slits may be being disposed through the conical member 24. The slits form the plurality of air openings 30 for providing oxygen to the interior soil, growing medium or the like. In this FIG. 4 embodiment, slits generally being horizontally disposed through the conical member 24. The conical member 24 may be introduced as a stand alone improvement, designed to fit within a plant container 14 or alternatively, the conical member 24 may be designed as a continuous part of the plant container 14 as depicted in FIG. 6.

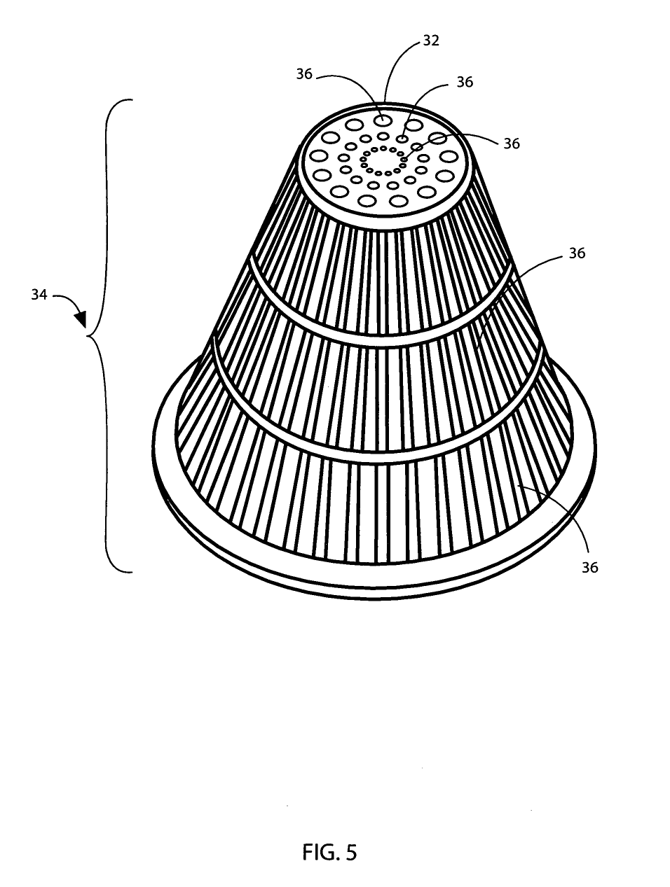

FIG. 5 is a perspective view of another embodiment of the present invention. The at least one top surface 32 of the conical member 34 may include a plurality of air openings 36. The plurality of air openings 36 may be a slot, hole or the like. The plurality of openings of the embodiment shown in FIG. 5 being generally disposed vertically through the conical member 34. The conical member 34 may be constructed in different size, shape and dimensions matching desired performance criteria. The conical member 34 may be designed for draining off excess or standing water from the container (not shown) thereby protecting the plant from over watering.

FIG. 6 is a perspective view of a plant container structure 40 showing a multi perspective rendering of the embodiment of FIG. 5. The container structure 40 may be constructed by utilizing plastic injection molding techniques. The plurality of air openings 42 generally being disposed vertically and/or horizontally through the plant container 44. While the present invention has been described in terms of specific embodiments, it is to be understood that the invention is not limited to the embodiments set forth herein.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A container structure for growing a plant to maturity comprising:
a container that includes at least one upwardly extending side wall having a top end and a bottom end, the bottom end being coupled with at least one bottom wall;
a conical member extending from a central position of the at least one bottom wall, the conical member being upwardly facing towards the top end; and
a plurality of air openings being disposed through the conical member;
whereby the conical member with the plurality of air openings integrated within the container is adapted to diffuse gaseous oxygen into the soil, growing medium or the like.

2. The container structure of claim 1 wherein the conical member comprises at least one top surface and at least one bottom surface.

3. The container structure of claim 1 wherein the conical member comprises at least one top surface and at least one bottom surface wherein the at least one top surface being smaller in surface area includes a plurality of air openings thereon.

4. The container structure of claim 1 wherein the plurality of air openings may increase from the at least one top surface to the at least one bottom surface.

5. The container structure of claim 1 wherein the plurality of air openings generally being disposed vertically and/or horizontally through the plant container.

6. The container structure of claim 1, wherein the plurality of air openings stop a distance from the bottom wall, said distance matching the desired water reservoir depth.

7. A container structure insert for growing a plant to maturity comprising:
a container that includes at least one upwardly extending side wall having a top end and a bottom end, the bottom end being coupled with at least one bottom wall;
a conical member inserted in the central position of the at least one bottom wall, the conical member being upwardly facing towards the top end; and
a plurality of air openings being disposed through the conical member;
whereby the conical member with the plurality of air openings inserted within the container is adapted to diffuse gaseous oxygen into the soil, growing medium or the like.

8. The container structure insert of claim 7 wherein the conical member comprises at least one top surface and at least one bottom surface.

9. The container structure insert of claim 7 wherein the conical member comprises at least one top surface and at least one bottom surface wherein the at least one top surface being smaller in surface area includes a plurality of air openings thereon.

10. The container structure insert of claim 7 wherein the plurality of air openings may increase from the at least one top surface to the at least one bottom surface.

11. The container structure insert of claim 7 wherein the plurality of air openings generally being disposed vertically and/or horizontally through the plant container.

12. The container structure insert of claim 7, wherein the plurality of air openings stop a distance from the bottom wall, said distance matching the desired water reservoir depth.
